(19) United States
(12) Patent Application Publication
(10) Pub. No.: US 2015/0084294 A1
(43) Pub. Date: Mar. 26, 2015

(54) STROLLER ACCESSORY

(71) Applicants: Jared Clanton, Cedar Hills, UT (US); Steven Batson, Orem, UT (US); Chris Batson, Lehi, UT (US)

(72) Inventors: Jared Clanton, Cedar Hills, UT (US); Steven Batson, Orem, UT (US); Chris Batson, Lehi, UT (US)

(21) Appl. No.: 14/201,535

(22) Filed: Mar. 7, 2014

Related U.S. Application Data
(60) Provisional application No. 61/880,537, filed on Sep. 20, 2013.

(51) Int. Cl. B62B 9/28

(52) U.S. Cl. CPC B62B 9/28
USPC 280/32.7

(57) ABSTRACT

A stroller accessory. The stroller accessory includes a seat where the seat is configured to allow a user to sit. The stroller accessory also includes one or more wheels. The one or more wheels are attached to the seat and are configured to allow the stroller accessory to move. The stroller accessory further includes an attachment, wherein the attachment is configured to attach the stroller accessory to a stroller.

### CROSS-REFERENCE TO RELATED APPLICATIONS

This application claims the benefit of and priority to U.S. Provisional Patent Application Ser. No. 61/880,537 filed on Sep. 20, 2013, which application is incorporated herein by reference in its entirety.

### BACKGROUND OF THE INVENTION

Travel with children can be an especially difficult endeavor. Children are not able to walk for as long as adults, they do not have a sense of time (so, for example, saying “ten more minutes” does not necessarily help them to understand how close or far to the destination) and they are more likely to need naps or other rests. Because of these, and other, issues parents often take strollers to give children a place to sit.

However, there are drawbacks to pushing children in a stroller. Foremost, for many parents, is that strollers normally either sit a limited number of children (most strollers fit a single child). Thus, parents with multiple children must either have the children take turns in the stroller or older children are not able to avail themselves of the stroller. I.e., smaller children are given priority for stroller use.

To alleviate this problem, parents may take multiple strollers. However, each stroller requires an adult, or older child, be available to push the stroller. I.e., each stroller requires a separate person to push the stroller. In addition, older children may need the stroller for only a portion of the time that younger children will need a stroller. I.e., some children do not constantly need a stroller. However, the stroller must be brought for the entirety of the outing in order to be available when needed. This means that an empty stroller, or a stroller with gear in the seat, is pushed around much of the day.

Accordingly, there is a need in the art for an accessory that can increase the available seating. Moreover, there is a need for the accessory to be detached when desired.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a stroller accessory. The stroller accessory includes a seat where the seat is configured to allow a user to sit. The stroller accessory also includes one or more wheels. The one or more wheels are attached to the seat and are configured to allow the stroller accessory to move. The stroller accessory further includes an attachment, wherein the attachment is configured to attach the stroller accessory to a stroller.

Another example embodiment includes a stroller accessory. The stroller accessory includes a seat where the seat is configured to allow a user to sit. The stroller accessory also includes one or more wheels. The one or more wheels are attached to the seat and are configured to allow the stroller accessory to move. The stroller accessory further includes a frame attached to the base. The stroller accessory additionally includes an attachment, wherein the attachment is configured to attach the stroller accessory to a stroller.

Another example embodiment includes a stroller accessory. The stroller accessory includes a seat where the seat is configured to allow a user to sit. The stroller accessory also includes one or more wheels. The one or more wheels are attached to the base and are configured to allow the stroller accessory to move. The stroller accessory further includes a frame attached to the base. The stroller accessory additionally includes a frame attached to the base. The stroller accessory moreover includes an attachment, wherein the attachment is configured to attach the stroller accessory to a stroller.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates the example of a stroller accessory attached to a stroller;

FIG. 1B illustrates an example of a stroller accessory with a user;

FIG. 2 illustrates an example of a stroller accessory;

FIG. 3 illustrates an alternative example of a stroller accessory with a cover;

FIG. 4A illustrates an example of an attachment which is connected; and

FIG. 4B illustrates an example of an attachment which has been disconnected.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

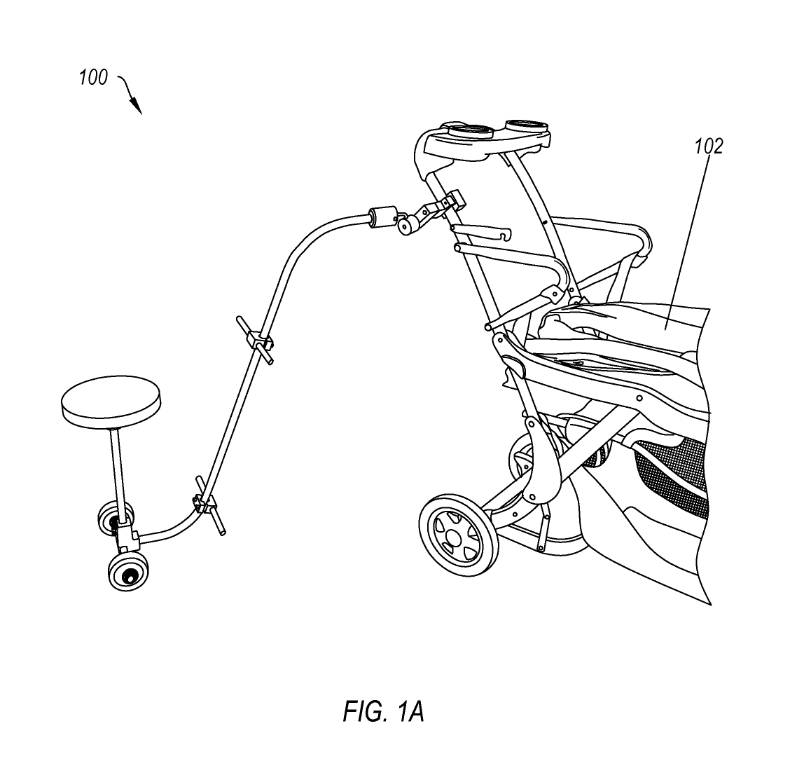

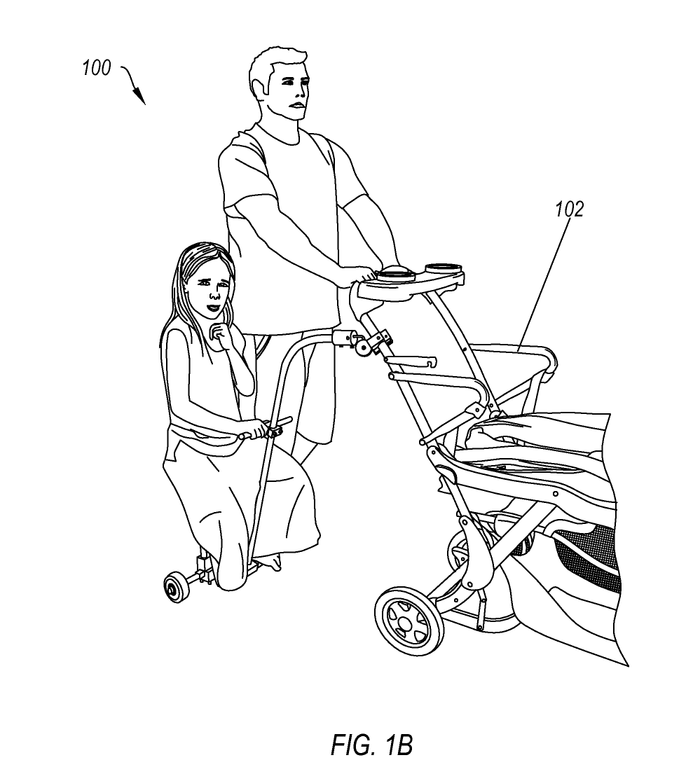

FIGS. 1A and 1B (collectively “FIG. 1”) illustrate an example of a stroller accessory 100 attached to a stroller 102. FIG. 1A illustrates the example of a stroller accessory 100 attached to a stroller 102; and FIG. 1B illustrates an example of a stroller accessory 100 with a user. The stroller accessory 100 allows a user to sit and move in concert with the stroller 102. I.e., the stroller accessory 100 is configured to attach to the stroller 102 and be moved with the stroller 102. Thus, additional users may sit on the stroller accessory 100 and additional materials may be stored on the stroller accessory 100, as described below.

Although the stroller 102 is used herein as exemplary of an external device to which the stroller accessory 100 will be attached, one of skill in the art will appreciate that the stroller accessory 100 can be used with any desired external device. For example, the stroller accessory 100 can be attached to luggage, to a bicycle, to a shopping cart, to another stroller accessory or any other desired device.

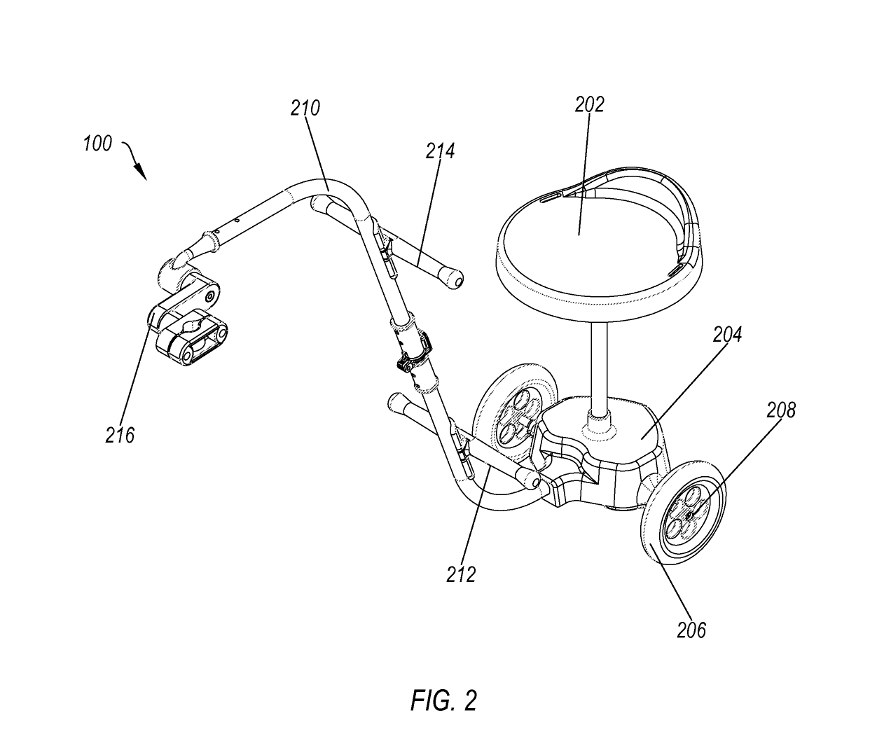

FIG. 2 illustrates an example of a stroller accessory 100. The stroller accessory 100 can provide transport for a child who is unable to sit in a stroller. I.e., the stroller accessory 100 is configured to attach to a stroller, providing additional seating and/or storage space. Attaching the stroller accessory 100 to a stroller allows a parent to push one unit, making the outing easier. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 2 shows that the stroller accessory 100 can include a seat 202. The seat 202 is a place for a child or other user to sit. I.e., a child or other user can sit on the seat 202. This allows the stroller accessory 100 to provide an additional seat that it is attached to the stroller. The seat 202 can include cushioning, restraints, a back, arm rests or any other desired elements to increase the comfort of the user. Additionally or alternatively, the seat 202 can be adjustable. I.e., the height can be changed to allow for the user to be seated at any desired height.

FIG. 2 also shows that the stroller accessory 100 can include a base 204. The base 204 supports the seat 202. I.e., the base 204 is configured to support the weight of the seat 202 and a user. In particular, when a user is on the seat 202, the weight of the user and the seat 202 itself must all be supported. The base 204 is made of any material which is of sufficient strength to support the weight of the seat 202 and the user, such as plastic, aluminum or steel.

FIG. 2 further shows that the stroller accessory 100 can include one or more wheels 206. The wheels 206 allow the stroller accessory 100 to move along with the stroller to which it is attached. I.e., as a force is applied to the stroller that force is transferred to the stroller accessory 100 which can then move via the wheels 206. The wheels 206 can include single wheels or pairs of wheels as desired. Additionally or alternatively, the wheels 206 can include casters. A caster (or castor) is an undriven, single, double, or compound wheel that is designed to be mounted to the bottom of a larger object so as to enable that object to be easily moved. They are available in various sizes, and are commonly made of rubber, plastic, nylon, aluminum, or stainless steel.

FIG. 2 additionally shows that the stroller accessory 100 can include an axle 208. The axle 208 allows the wheels 206 to rotate freely. I.e., the wheels 206 rotate about the axle 208 allowing the stroller accessory 100 to be moved as desired. One of skill in the art will appreciate that multiple axles 208 will allow for a greater range of motion for the stroller accessory 100. I.e., if each wheel or set of wheels has a separate axle 208 then the wheels or sets of wheels can move independently of one another.

FIG. 2 moreover shows that the stroller accessory 100 can include a frame 210. The frame 210 is connected to the base 204 and the stroller. I.e., the frame 210 transfers force that is used to push the stroller to the base 204, moving the stroller accessory 100 in concert with the stroller. Thus, the individual pushing the stroller moves both the stroller and the stroller accessory 100. Additionally or alternatively, the frame 210 can be used for mounting other auxiliary devices. For example, a basket, a cover from the elements, a base platform (for standing rather than sitting, or for standing tandem behind a seated child), steering wheel, gear shifter, instrumentation panel, wheel fenders, hitch for attaching following stroller accessory 100, gas tank, head and tail lights, muffler, handle bars, handle throttle, windshield, brakes, other general accessories that lend to automotive and/or motorcycle styling, bells and noisemakers, an enclosed seat, seat belt, accessory bags, battery powered accessories, heater, flag pole, radio or any other auxiliary devices can be attached to the frame 210.

The frame 210 can be adjustable to allow for connection to different strollers. I.e., the frame 210 can include a lower portion and an upper portion which can be adjusted relative to one another. I.e., the upper portion can be at least partially inserted into the lower portion (or vice versa) and move relative to the lower portion. This changes the overall length of the frame 210 which allows for the connection point to the stroller to be customized to any stroller.

One of skill in the art will appreciate that the frame 210 can allow the stroller accessory 100 to be folded. For example, the frame 210 can include one or more hinges which allow the frame to be collapsible, allowing for easier transport or storage. Additionally or alternatively, the base 204, the wheels or any other attached element can be folded to the frame 210. E.g., the base 204 can include one or more hinges at the attachment point between the base 204 and the frame 210, allowing the base 204 to be folded for storage or when use of the base 204 is not desired.

FIG. 2 also shows that the stroller accessory 100 can include a foot rest 212. The foot rest 212 provides a space for the user's feet. I.e., the foot rest 212 allows a user to raise his/her feet to prevent them from dragging on the ground where they would impede motion of the stroller accessory 100. Additionally or alternatively, the foot rest 212 can be configured to support a storage area. I.e., the foot rest 212 can allow for installation of a storage area into which the user may place items. The foot rest 212 can be attached to the frame 210. Additionally or alternatively, the foot rest 212 can be folded to the frame 210. I.e., the foot rest 212 can include one or more hinges at the attachment point between the foot rest 212 and the frame 210, allowing the foot rest 212 to be folded for storage or when use of the foot rest 212 is not desired.

FIG. 2 further shows that the stroller accessory 100 can include a handle 214. The handle 214 allows a user to hold on to avoid falling while the stroller accessory 100 is being moved. I.e., the user can steady himself/herself while on the seat 202. The handle 214 can be attached to the frame 210. Additionally or alternatively, the handle 214 can be folded to the frame 210. I.e., the handle 214 can include one or more hinges at the attachment point between the handle 214 and the frame 210, allowing the handle 214 to be folded for storage or when use of the handle 214 is not desired.

FIG. 2 additionally shows that the stroller accessory 100 can include an attachment 216. The attachment 216 is configured to connect the stroller accessory 100 to the stroller. In particular, the attachment 216 can be configured to allow the stroller accessory 100 to be attached and released as desired by the user. This can allow the user to attach and detach the stroller accessory as desired and as described below.

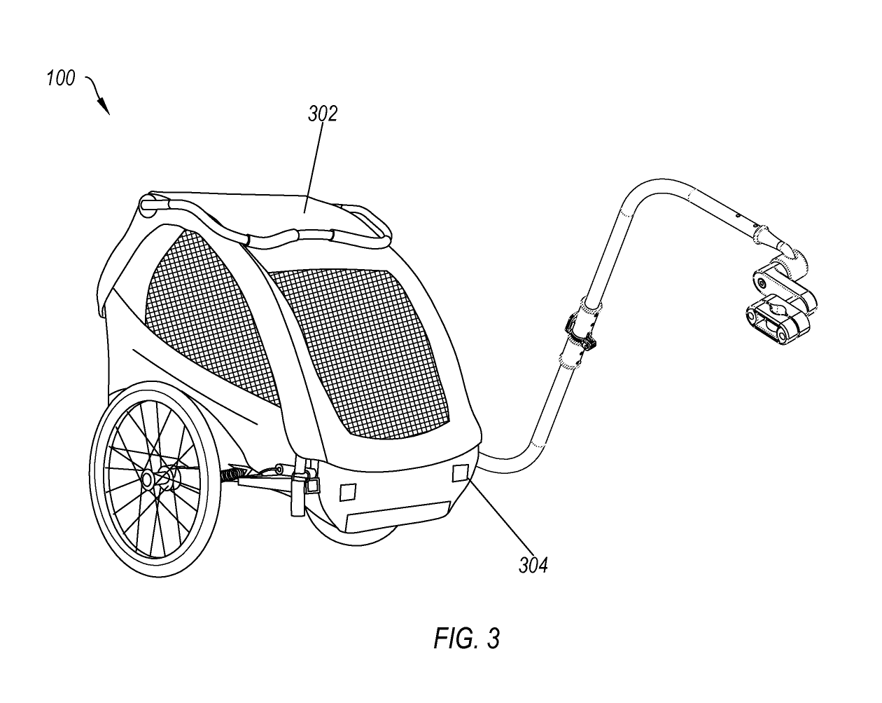

FIG. 3 illustrates an alternative example of a stroller accessory 100 with a cover 302. I.e., the seat is within a space that can is under the cover 302 to remove light and or to protect the child from the elements. That is, the child can sleep within the seat or can sit on the seat under the cover. The cover 302 blocks wind, rain, light or other environmental conditions from the seat area.

FIG. 3 shows that the stroller accessory 100 can include one or more safety devices 304. The safety devices 304 can include anything which makes the stroller accessory 100 more noticeable or helps the child to remain in the stroller accessory 100. For example the safety devices 304 can include a door, reflectors, or any other desired safety device.

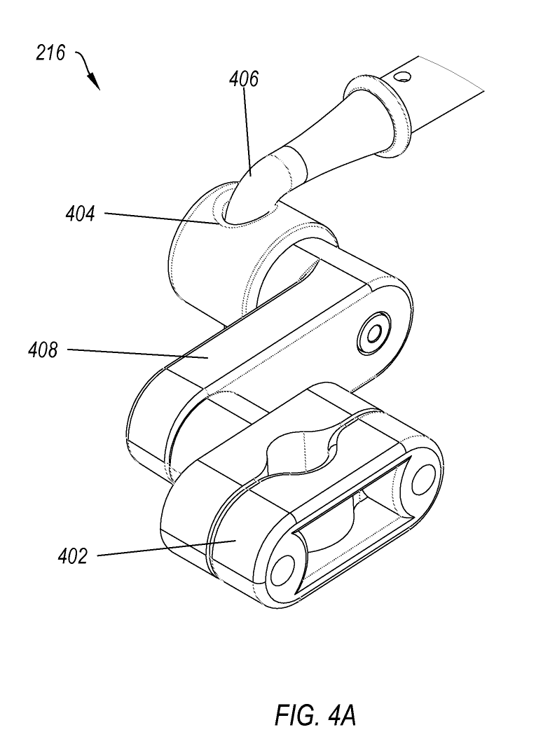

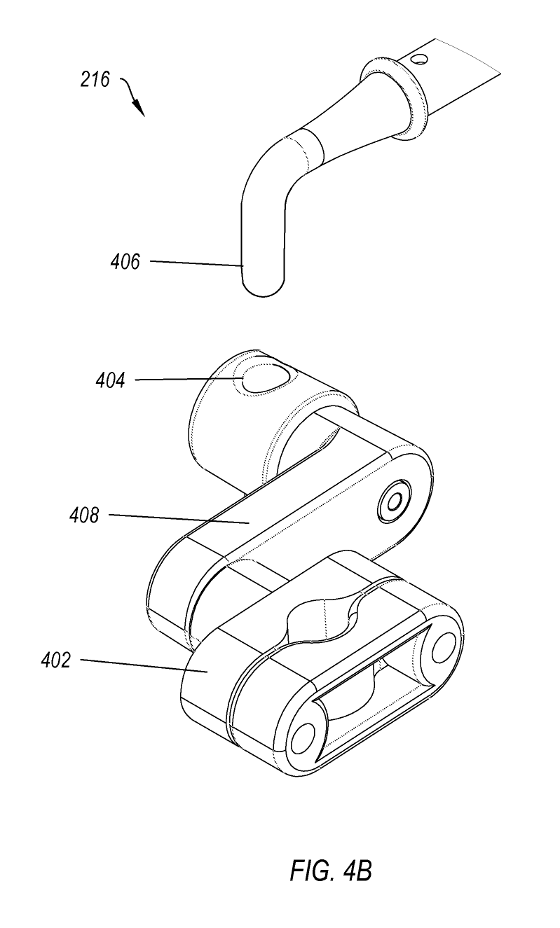

FIGS. 4A and 4B (collectively “FIG. 4”) illustrate an example of an attachment 216. FIG. 4A illustrates an example of an attachment 216 which is connected; and FIG. 4B illustrates an example of an attachment 216 which has been disconnected. The attachment 216 is configured to attach a stroller accessory to a stroller. In particular, the attachment 216 allows a pushing or other moving force on a stroller to be transferred to the stroller accessory 100 allowing the stroller to “tow” the stroller accessory.

FIG. 4 shows that the attachment 216 can include a clamp 402. The clamp 402 is configured to secure to the stroller. I.e., the clamp 402 is a portion that is attached permanently to the stroller, allowing a stroller accessory to be removed when desired. In particular, the clamp 402 includes two portions that are attached to one another with a portion of the stroller in between. The force on the two portions of the clamp 402 are sufficient that the clamp cannot move relative to the stroller.

FIG. 4 also shows that the attachment 216 can include a receiver 404. The receiver is configured to releasably receive a portion of the stroller accessory. I.e., a portion of the stroller accessory is inserted into, or otherwise attached to, the receiver 404. The connection then allows the stroller accessory and the stroller to move in concert with one another and to be removed when desired.

FIG. 4 further shows that the attachment 216 can include a post 406. The post 406 is configured to be placed within the receiver 404. I.e., the post 406 is smaller than the receiver 404 and is placed within the receiver 404 when the user desires to attach the stroller accessory to the stroller. One of skill in the art will appreciate that the stroller is being pushed laterally; therefore, gravity keeps the post 406 within the receiver 404 and lateral forces are transferred to the stroller accessory. Additionally or alternatively, a safety lock can be used to ensure that the post 406 remains in place. I.e., the safety lock can hold the post 406 in relation to the receiver 404.

FIG. 4 additionally shows that the attachment 216 can include an adjustment arm 408. The adjustment arm is configured to change the orientation of the receiver 404 and the clamp 402 to one another. In particular, the adjustment arm 408 can allow the clamp 402 to be attached to an external object and the orientation of the receiver 404 to be adjusted in order to receive the post 406 when use of the stroller attachment is desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A stroller accessory, the stroller accessory comprising:
a seat, wherein the seat is configured to allow a user to sit;
one or more wheels, wherein the one or more wheels:
are attached to the seat; and
are configured to allow the stroller accessory to move;
an attachment, wherein the attachment is configured to attach the stroller accessory to a stroller.

2. The stroller accessory of claim 1, wherein the seat includes cushioning.

3. The stroller accessory of claim 1, wherein the seat includes a restraint.

4. The stroller accessory of claim 1, wherein the height of the seat is adjustable.

5. The stroller accessory of claim 1, wherein the seat includes a cover.

6. The stroller accessory of claim 1, wherein the attachment includes a clamp, the clamp configured to secure to a portion of the stroller.

7. The stroller accessory of claim 6, wherein the clamp includes:
a first portion; and
a second portion configured to be secured to the first portion;
wherein the first portion and the second portion surround and hold a portion of the stroller.

8. The stroller accessory of claim 1, wherein the attachment includes:
a post attached to the frame; and
a receiver configured to:
be secured to the stroller; and
receive the post.

9. A stroller accessory for, the stroller accessory comprising:
a seat, wherein the seat is configured to allow a user to sit;
one or more wheels, wherein the one or more wheels:
are attached to the seat; and
are configured to allow the stroller accessory to move;
a frame attached to the seat;
an attachment, wherein the attachment is configured to attach the stroller accessory to a stroller.

10. The stroller accessory of claim 9, wherein the size of the frame is adjustable.

11. The stroller accessory of claim 9, wherein the frame includes:
a first portion; and
a second portion, wherein the second portion:
resides at least partially within the first portion; and
is configured to move relative to the first portion.

12. The stroller accessory of claim 9, wherein the frame includes ore or more hinges configured to allow a user to fold the frame.

13. A stroller accessory for, the stroller accessory comprising:
a seat, wherein the seat is configured to allow a user to sit;
a base, wherein the seat is supported by the base;
one or more wheels, wherein the one or more wheels:
are attached to the base; and
are configured to allow the stroller accessory to move;
a frame attached to the base;
an attachment, wherein the attachment is configured to attach the stroller accessory to a stroller.

14. The stroller accessory of claim 13 further comprising:
an axle, wherein:
the axle passes through and is attached to the base; and
the pair of wheels are attached to the axle.

15. The stroller accessory of claim 13 further comprising one or more safety features.

16. The stroller accessory of claim 15, wherein the one or more safety features includes a reflector.

17. The stroller accessory of claim 15, wherein the one or more safety features includes a door.

18. The stroller accessory of claim 13 further comprising a foot rest.

19. The stroller accessory of claim 13 further comprising a handle.
